(19) United States
(12) Patent Application Publication
(10) Pub. No.: US 2026/0213704 A1
(43) Pub. Date: Jul. 23, 2026

(54) RAINWATER GUIDE COVER AND PHOTOVOLTAIC POWER GENERATION SYSTEM

(71) Applicant: TAKASHIMA & CO., LTD., Tokyo (JP)

(72) Inventor: Masaki Kishimoto, Anjyo-shi (JP)

(73) Assignee: TAKASHIMA & CO., LTD., Tokyo (JP)

(21) Appl. No.: 19/563,678

(22) Filed: Mar. 11, 2026

Related U.S. Application Data
(63) Continuation of application No. PCT/JP2023/033232, filed on Sep. 12, 2023.

(51) Int. Cl. H02S 40/10; H02S 30/10

(52) U.S. Cl. CPC H02S 40/10; H02S 30/10

(57) ABSTRACT

A rainwater guide cover includes a top plate to cover above a part on an eaves side of a fastening device that attaches a photovoltaic module to a roof and is arranged with a gap from the photovoltaic module, and a side plate provided to the top plate to cover an eaves side of the photovoltaic module and include a lower end arranged to face a rain gutter.

### CROSS-REFERENCE TO RELATED APPLICATION

This application is a Continuation Application of PCT Application No. PCT/JP2023/033232, filed Sep. 12, 2023, the entire contents of which are incorporated herein by reference.

### FIELD

The present invention relates generally to a rainwater guide cover used in a fastening device to fasten a photovoltaic module to an installation place and a photovoltaic power generation system.

### BACKGROUND

Photovoltaic power generation systems for generating power using multiple photovoltaic modules fastened, for example, to a roof of a house have been known. The photovoltaic module includes, for example, a solar panel and a frame that holds a periphery of the solar panel. As a technique to fasten such a photovoltaic module to a roof, Jpn. Pat. Appln. KOKAI Publication No. 2018-109322 discloses a technique in which a base member is fastened between two adjacent photovoltaic modules on a roof, and a pressing member for pressing edge portions of the two adjacent photovoltaic modules is fastened to the base member by bolts and nuts.

### SUMMARY

According to an aspect of the embodiment, a rainwater guide cover includes a top plate to cover above a part on an eaves side of a fastening device that attaches a photovoltaic module to a roof and is arranged with a gap from the photovoltaic module, and a side plate provided on the top plate to cover an eaves side of the photovoltaic module and include a lower end arranged to face a rain gutter.

### BRIEF DESCRIPTION OF THE DRAWING(S)

FIG. 1 is an exploded perspective view illustrating a configuration of a photovoltaic power generation system according to a first embodiment of the present invention.

FIG. 2 is a side view illustrating a state in which main components of the photovoltaic power generation system are installed on a roof.

FIG. 3 is a flow chart illustrating an example of a method of installing a module cover, which is a configuration of a fastening device and a module cover of the photovoltaic power generation system.

FIG. 4 is a flow chart illustrating an example of a configuration and a method of installing a fastening device and a module cover of a photovoltaic power generation system according to a second embodiment of the present invention.

FIG. 5 is a perspective view illustrating a configuration of a fastening device and a module cover of a photovoltaic power generation system according to a third embodiment of the present invention.

FIG. 6 is a side view illustrating an example of the configuration and a method of installing the fastening device and the module cover.

FIG. 7 is a flow chart illustrating an example of a configuration and a method of installing a fastening device and a module cover of a photovoltaic power generation system according to a fourth embodiment of the present invention.

### DETAILED DESCRIPTION

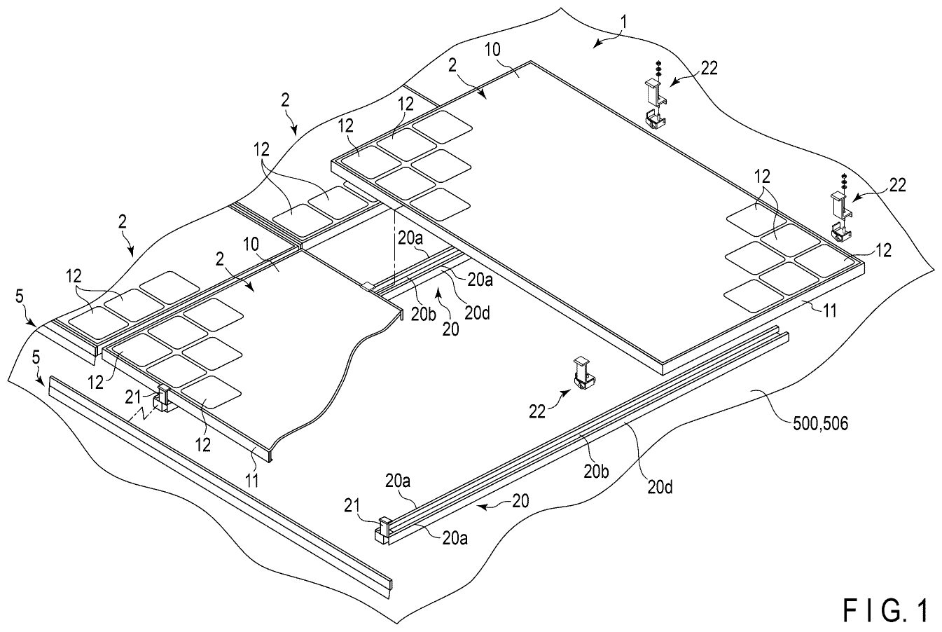

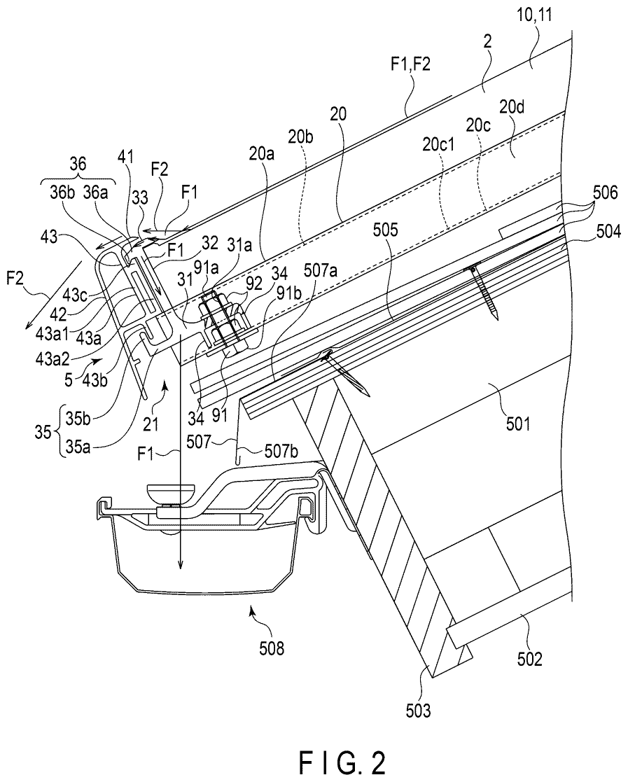

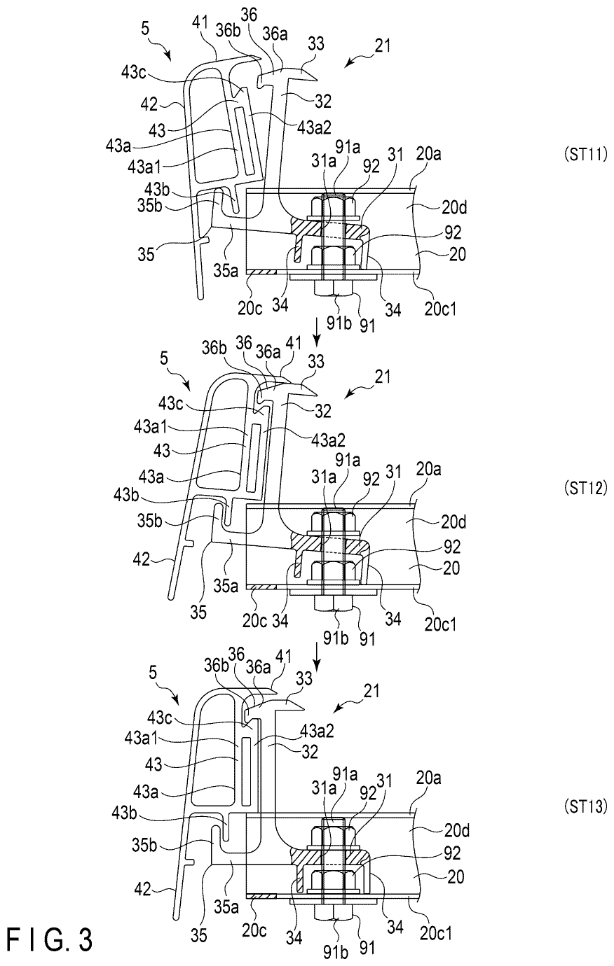

A module cover 5 and a photovoltaic power generation system 1 using the module cover 5 according to an embodiment of the present invention will be described with reference to FIGS. 1 to 3. FIG. 1 is an exploded perspective view illustrating a configuration of the photovoltaic power generation system 1. FIG. 2 is a side view showing a configuration of main components of the photovoltaic power generation system 1 installed on a roof 500. FIG. 3 is a flow chart illustrating an example of a method of installing the module cover 5, which is a configuration of the fastening device 3 and the module cover 5 of the photovoltaic power generation system 1.

As illustrated in FIGS. 1 and 2, the photovoltaic power generation system 1 is installed on the roof 500 of a house. First, a specific example of the roof 500 will be described. As illustrated in FIG. 2, the roof 500 includes, for example, a plurality of rafters 501, an eaves soffit 502 provided below the rafters 501 on the eaves side, a fascia board 503 covering end portions of the rafters 501 and the eaves soffit 502, a roof board 504 provided on the plurality of rafters 501, an underlayment material 505 provided on the roof board 504, a plurality of straight roofing members 506 provided on the underlayment material 505, and a drip edge 507 provided on the end portion of the roof board 504. The roof 500 further includes a rain gutter 508 provided to the fascia board 503 and provided below the drip edge 507.

The drip edge 507 is provided along a width direction of eaves. The drip edge 507 includes, for example, a base portion 507a arranged between the roof board 504 and the underlayment material 505 at the eaves, and a drip edge flashing 507b hanging downward from an end portion of the base portion 507a on the eaves side. The drip edge flashing 507b faces the rain gutter 508 in a hanging direction.

Next, the photovoltaic power generation system 1 will be described. As illustrated in FIG. 1, the photovoltaic power generation system 1 includes the plurality of photovoltaic modules 2, the fastening device 3, and the module cover 5 provided on the plurality of fastening devices 3 on the eaves side. The fastening device 3 and the module cover 5 constitute a fastening device for a photovoltaic module.

The plurality of photovoltaic modules 2 are mounted on the roof 500 by the fastening device 3. The plurality of photovoltaic modules 2 are arranged in two directions, for example, a direction in which the ridge and the eaves are opposed to each other and a direction orthogonal to the opposing direction of the ridge and the eaves, that is, a direction along the ridge and the eaves. The number of the photovoltaic modules 2 is appropriately set depending on the size of an installation place, a required output, and the like.

The photovoltaic module 2 is shaped into a plate. The photovoltaic module 2 includes, for example, a solar panel 10 and a frame 11. The solar panel 10 includes a plurality of plate-shaped cells 12 formed of solar cell elements, which are arranged aligned in two directions. In FIG. 1, the solar panel 10 is illustrated with some of the cells 12 omitted. The solar panel 10 is formed in a rectangular plate shape, for example.

As illustrated in FIG. 1, the frame 11 is provided to an edge portion of the solar panel 10. The frame 11 includes a base material made of a metal material having conductivity, and a protective layer provided on a surface of the base material to prevent corrosion. The protective layer is formed by, for example, plating the base material.

The frame 11 is formed to be thicker than the solar panel 10, for example, and holds the solar panel 10 in an upper end side.

As illustrated in FIG. 1, the fastening device 3 includes, for example, a plurality of rack members 20 that are long in one direction, a plurality of first fastening brackets 21 that are provided on the eaves side of each rack member 20, and a plurality of second fastening brackets 22 that are arranged closer to the ridge side than the first fastening brackets 21 of each rack member 20. For example, the fastening device 3 fastens the photovoltaic module 2 on the eaves side onto the rack members 20 by the same number of the first fastening brackets 21 as the rack members 20 and the same number of the second fastening brackets 22 as the rack members 20, which are provided to the plurality of rack members 20 that hold the photovoltaic module 2 on an upper surface. Further, in a case where a plurality of photovoltaic modules 2 are fastened side by side in the direction in which the eaves and the ridge are opposed to each other (that is, an extending direction of the rack member 20), the fastening device 3 fastens the photovoltaic module 2 other than the photovoltaic module 2 on the eaves side by the same number of the second fastening brackets 22 as the rack member 20 on each of the eaves side and the ridge side of the photovoltaic module 2.

For example, two or more rack members 20 are provided for one photovoltaic module 2 in the direction along the ridge and the eaves. In the example of FIG. 1, for example, two rack members 20 are provided in a direction along the eaves and the ridge for one photovoltaic module 2. For example, the rack member 20 is fastened across the plurality of roofing members 506, in a posture in which the longitudinal direction is along the opposing direction of the ridge and the eaves. The rack member 20 is formed to have a length in a longitudinal direction (that is, a direction in which the ridge and the eaves are opposed to each other) that allows the plurality of photovoltaic modules 2 to be arranged. In the example of FIG. 1, the rack member 20 is formed such that two photovoltaic modules 2 can be arranged.

The rack member 20 is formed of a metal material. The rack member 20 has, on upper surface portions, a pair of support plate portions 20a (upper surface portions) that come into contact with lower surfaces of the frame 11 of the photovoltaic module 2. In the rack member 20, a slit-shaped opening portion 20b long in one direction is formed between a pair of support plate portions 20a extending along the longitudinal direction. The rack member 20 is a hollow rectangular tubular pipe member having a shape in which the support plate portion 20a is continuous on the side opposite to the opening portion 20b.

That is, the rack member 20 includes a bottom wall portion 20c that faces the roofing member 506, a pair of side wall portions 20d integrally formed with the bottom wall portion 20c, and a pair of support plate portions 20a integrally formed with upper ends of the pair of side wall portions 20d and forming the slit-shaped opening portion 20b extending along the longitudinal direction of the rack member 20. For example, the rack member 20 has a hole 20c1 formed in the bottom wall portion 20c. The hole 20c1 is a circular hole or a long hole that is long in one direction, and the hole 20c1 is smaller than a minimum width of a head portion 91b of a bolt 91 and has a width that allows a male screw 91a of the bolt 91 to be inserted. A bolt 91 to fasten the first fastening bracket 21 and/or the second fastening bracket 22 is inserted into the hole 20c1 formed in the bottom wall portion 20c, and a nut 92 is fastened to the bolt 91, to thus fasten the bolt 91 to the bottom wall portion 20c.

As a material of the rack member 20, for example, a metal material such as aluminum, stainless steel, or iron, or a resin material can be used. In the present embodiment, the rack member 20 is manufactured by bending a rectangular metal plate that is long in one direction at a plurality of locations along the longitudinal direction.

In a direction orthogonal to the longitudinal direction of the rack member 20, a width of the first fastening bracket 21 is narrower than the width of the opening portion 20b formed in the rack member 20. As illustrated in FIG. 2, the first fastening bracket 21 is, for example, fastened to the rack member 20 by fastening members such as the bolt 91 and the nut 92. As a specific example, the first fastening bracket 21 includes a base portion 31, a wall portion 32 having a lower end formed integrally with the base portion 31 and having one main surface that faces the photovoltaic module 2, a support portion 33 formed integrally with an upper end of the wall portion 32, and a pair of leg portions 34 formed integrally with a main surface (lower surface) of the base portion 31 facing the bottom wall portion 20c of the rack member 20. The first fastening bracket 21 includes a first engaging portion 35 integrally formed on the base portion 31 side of the main surface of the wall portion 32 on the side opposite to that facing the photovoltaic module 2, and a second engaging portion 36 integrally formed on the support portion 33 side on the main surface of the wall portion 32 on the side opposite to that facing the photovoltaic module 2. The first fastening bracket 21 is formed by, for example, extrusion molding or the like.

The base portion 31 is formed in, for example, a rectangular plate shape. The base portion 31 is formed with a hole 31a into which a male screw 91a of the bolt 91 can be inserted. For example, an inside diameter of the hole 91a formed in the base portion 31 is formed to be larger than an outside diameter of the male screw 91a, such that the male screw 91a of the bolt 91 and the base portion 31 can be inclined more than an axial direction of the male screw 91a and the direction to which the main surface direction of the base portion 31 is orthogonal.

The wall portion 32 is formed in a rectangular plate shape and extends from the upper surface of the base portion 31 in a direction orthogonal to the upper surface of the base portion 31. One main surface of the wall portion 32 is formed, for example, to be able to abut on the frame 11 of the photovoltaic module 2. The other main surface of the wall portion 32 faces the module cover 5.

The support portion 33 is provided at the upper end of the wall portion 32 and protrudes toward the photovoltaic module 2 side in a direction orthogonal to the main surface of the wall portion 32. A lower surface of the support portion 33 is formed, for example, in a flat shape. An upper surface of a tip end of the end portion of the support portion 33, which is on the side opposite to the wall portion 32, is formed such that the upper surface on the side opposite to the base portion 31 side is inclined to make the thickness decrease toward the tip end. For example, in a state in which the first fastening bracket 21 is fastened to the rack member 20, a distance between an upper surface of the rack member 20 and a lower surface of the support portion 33 is slightly greater than a thickness of the frame 11, that is, a height of the frame 11 in a direction in which the upper surface of the rack member 20 and the lower surface of the support portion 33 face each other in a state in which the photovoltaic module 2 is arranged on the rack member 20, such that the photovoltaic module 2 can be inserted and arranged.

The leg portions 34 are provided on a main surface (lower surface) of the base portion 31 on the opposite side to the main surface (upper surface) on which the wall portion 32 is provided. A pair of the leg portions 34 are arranged aligned in one direction. As a specific example, the pair of leg portions 34 are arranged aligned in the longitudinal direction of the rack member 20. A distance between the pair of leg portions 34 is greater than a maximum width of the nut 92 so as to be able to arrange the nut 92.

The first engaging portion 35 is formed engageable with the module cover 5 in one direction. For example, the first engaging portion 35 is formed engageable with the module cover 5 in a direction along the longitudinal direction of the rack member 20. As a specific example, the first engaging portion 35 includes a first extending portion 35a and a first engaging wall 35b. The first extending portion 35a extends along the main surface direction of the base portion 31 and is formed integrally with the base portion 31 and the wall portion 32. The first engaging wall 35b is formed at an end portion of the first extending portion 35a on the opposite side to the base portion 31 and the wall portion 32 side, and extends in a direction orthogonal to the extending direction of the first extending portion 35a, that is, a direction orthogonal to the main surface direction of the base portion 31, in other words, a direction along the extending direction of the wall portion 32, that is, the same direction as the wall portion 32, and extends upward. The first engaging wall 35b engages with the module cover 5 in the case where the module cover 5 moves in a direction of separation away from the first fastening bracket 21, and restricts the movement of the module cover 5. The main surface of the first engaging wall 35b facing the wall portion 32 is, for example, along the main surface direction (extending direction) of the wall portion 32.

The second engaging portion 36 is formed engageable with the module cover 5 in one direction. For example, the second engaging portion 36 is formed engageable with the module cover 5 in a direction along the longitudinal direction of the rack member 20. As a specific example, the second engaging portion 36 includes a second extending portion 36a and a second engaging wall 36b. The second extending portion 36a extends along the main surface direction of the base portion 31 and is formed integrally with the wall portion 32. The second engaging wall 36b is formed at an end portion of the second extending portion 36a on the side opposite to the base portion 31 and the wall portion 32 side and extends in a direction orthogonal to the extending direction of the second extending portion 36a, that is, a direction orthogonal to the main surface direction of the base portion 31, in other words, the extending direction of the wall portion 32.

The upper surface of the second extending portion 36a is inclined as a runoff portion, for example, to prevent interference with the module cover 5 during attaching of the module cover 5. The second engaging wall 36b engages with the module cover 5 in a case where the module cover 5 moves in a direction of separation away from the first fastening bracket 21, and restricts the movement of the module cover 5. The main surface of the second engaging wall 36b that faces the wall portion 32 is inclined, for example, to separate from the wall portion 32 from the second extending portion 36a side toward the tip end of the second engaging wall 36b with respect to the main surface direction (extending direction) of the wall portion 32.

The first fastening bracket 21 configured as described above is fastened to the rack member 20 by the bolt 91 fastened to the bottom wall portion 20c of the rack member 20 by the nut 92 being inserted into the hole 31a of the base portion 31, and the upper surface of the base portion 31 being fastened by the nut 92.

The second fastening bracket 22 is fastened to the rack member 20 by, for example, a bolt 91 and a nut 92. The second fastening bracket 22 is formed, for example, so as to press the eaves-side photovoltaic module 2 toward the rack member 20, and to allow the ridge-side photovoltaic module 2 to be inserted and to restrict upward movement of the photovoltaic module 2 from the upper surface of the rack member 20.

The module cover 5 covers, for example, the side surface of the eaves side of the frame 11 of the photovoltaic module 2. The module cover 5 covers at least a part above the first fastening bracket 21, which is above a part of the eaves side of the fastening device 3. The module cover 5 is a rainwater guide cover that makes the rainwater flowing on the upper surface of the photovoltaic module 2 move inward and downward, and guides the rainwater to the rain gutter 508 provided on the eaves. The module cover 5 includes, for example, a top plate 41, a side plate 42, and a to-be-engaged portion 43. The top plate 41, the side plate 42, and the to-be-engaged portion 43 are formed to have a same length in one direction, for example.

The top plate 41 does not cover the upper surface of the solar panel 10 of the photovoltaic module 2, and does not cover the upper surface of the frame 11 of the photovoltaic module 2 or covers a part of the upper surface of the frame 11, for example. That is, the top plate 41 is arranged in a position in which the solar panel 10 is not covered by a shadow created by the top plate 41 in a case where the sun is located at a predetermined position with respect to the solar panel 10. The lower surface of the top plate 41 facing the rack member 20 is arranged in a position higher than the upper surface of the frame 11 in a direction orthogonal to the upper surface of the rack member 20. Accordingly, the top plate 41 forms a gap between the top surface of the photovoltaic module 2 and the top plate 41, and rainwater flowing on the photovoltaic module 2 can move to below the top plate 41.

As a specific example, the top plate 41 is formed in a flat plate shape, and the upper surface is formed inclined such that the end portion (tip end) to the photovoltaic module 2 side (ridge side) is tapered. In a case where the module cover 5 is fastened to the first fastening bracket 21, the top plate 41 is separated from the upper end of the wall portion 32 of the first fastening bracket 21 and the upper surface of the second engaging portion 36. In the case where the module cover 5 is fastened to the first fastening bracket 21, the tip end of the top plate 41 is, for example, located above the wall portion 32 and is not located above the support portion 33. That is, in the case where the module cover 5 is fastened to the first fastening bracket 21, the tip end of the top plate 41 is provided in a position retracted from above the photovoltaic module 2 supported by the first fastening bracket 21, that is, substantially the same as the edge portion of the frame 11 or closer to the eaves side than the frame 11.

The side plate 42 is, for example, along a direction orthogonal to the upper surface of the rack member 20, in other words, a direction in which the rack member 20 and the support portion 33 face each other, or is inclined. The side plate 42 constitutes a decorative cover that covers the eaves-side side surface of the frame 11. In a state where the module cover 5 is fastened to the fastening device 3, the lower end of the side plate 42 is arranged above the rain gutter 508. Further, in a state where the module cover 5 is fastened to the fastening device 3, the side plate 42 is arranged, for example, in a position farther away from the roof 500 than the drip edge 507.

The to-be-engaged portion 43 includes, for example, a base portion 43a continuous with the top plate 41 and the side plate 42, a first to-be-engaged portion 43b provided to the base portion 43a, and a second to-be-engaged portion 43c provided to the base portion 43a.

The base portion 43a is formed integrally with the top plate 41, the side plate 42, the first to-be-engaged portion 43b, and the second to-be-engaged portion 43c. For example, the base portion 43a is formed in a shape that improves rigidity of the top plate 41, the side plate 42, the first to-be-engaged portion 43b, and the second to-be-engaged portion 43c. For example, the base portion 43a includes a first base portion 43a1 that forms a rectangular hollow portion together with the top plate 41 and the side plate 42, and a second base portion 43a2 that is integrally provided with the first base portion 43a1 and forms a hollow portion smaller than the hollow portion formed by the first base portion 43a1.

The first base portion 43a1 is formed, for example, in an L-shape in a side view, and is formed integrally with the top plate 41 and the side plate 42. The second base portion 43a2 is integrally formed on a side surface of the first base portion 43a1 on the opposite side to the side plate 42, and is formed in a rectangular cylindrical shape together with a part of the first base portion 43a1. For example, a lower surface of the first base portion 43a1 on the side opposite to the top plate 41 side and a lower surface of the second base portion 43a2 on the side opposite to the top plate 41 side are formed on a same plane. An upper surface of the second base portion 43a2 facing the top plate 41 is formed with a gap from the top plate 41.

The base portion 43a is not limited to the configuration in which the hollow portion is formed by the first base portion 43a1 and the second base portion 43a2. For example, the first base portion 43a1 and/or the second base portion 43a2 may have a columnar shape that is long in the longitudinal direction of the module cover 5 without forming a hollow portion.

The first to-be-engaged portion 43b is formed, for example, on a lower surface of the base portion 43a on the side opposite to the top plate 41. The first to-be-engaged portion 43b is formed in a plate shape. The first to-be-engaged portion 43b is, for example, formed so as to be able to face a main surface of the first engaging wall 35b facing the wall portion 32 in the longitudinal direction of the rack member 20, in the case where the module cover 5 is fastened to the first fastening bracket 21.

The second to-be-engaged portion 43c is formed, for example, in a protruding shape provided on the upper surface of the second base portion 43a2. The upper end of the second to-be-engaged portion 43c facing the top plate 41 is separated from the top plate 41 by a predetermined gap. The upper end surface of the second to-be-engaged portion 43c is formed in a flat shape, and the surface of the second to-be-engaged portion 43c on the first base portion 43a1 side is formed, for example, at the same inclination angle as the second engaging wall 36b. Further, the surface of the second to-be-engaged portion 43c on the opposite side to the first base portion 43a1 is formed in a flat shape and is formed on the same surface as the surface of the second base portion 43a2 on the opposite side to the first base portion 43a1.

For example, a length from the upper end of the second to-be-engaged portion 43c to the lower surface of the second base portion 43a2 is formed to be a same length as a length from the upper surface of the rack member 20 to the lower surface of the second extending portion 36a of the second engaging portion 36 in the state in which the first fastening bracket 21 is fastened to the rack member 20.

The first to-be-engaged portion 43b and the second to-be-engaged portion 43c engage with the first engaging wall 35b of the first engaging portion 35 and the second engaging wall 36b of the second engaging portion 36 in the longitudinal direction of the rack member 20 and in a direction of separation away from the wall portion 32.

Next, a method of attaching the module cover 5 configured as described above will be described with reference to FIG. 3.

First, as illustrated in step ST11 of FIG. 3, the bolt 91 is inserted into the hole 20c1 of the bottom wall portion 20c of the rack member 20 from the lower surface side of the bottom wall portion 20c, and the bolt 91 and the nut 92 are fastened to fasten the bolt 91 to the bottom wall portion 20c. Next, the male screw 91a is inserted into the hole 31a of the base portion 31 of the first fastening bracket 21, the first fastening bracket 21 is arranged in the rack member 20, and the nut 92 is screwed to the male screw 91a and temporarily fastened. At this time, since the inside diameter of the hole 31a of the base portion 31 is larger than the outside diameter of the male screw 91a, the first fastening bracket 21 can be inclined toward the ridge side as illustrated in step ST11 of FIG. 3. Further, by making the first fastening brackets 21 incline toward the ridge side, the distance between the upper surface of the rack member 20 and the second engaging portion 36 becomes larger than the distance between the lower surface of the second base portion 43a2 and the upper end of the second to-be-engaged portion 43c of the module cover 5.

Next, as illustrated in step ST12 of FIG. 3, the first to-be-engaged portion 43b of the module cover 5 is made to face the first engaging wall 35b of the first engaging portion 35 of the first fastening bracket 21, and the second to-be-engaged portion 43c of the module cover 5 is engaged with the second engaging wall 36b of the second engaging portion 36 of the first fastening bracket 21.

Next, as illustrated in step ST13 of FIG. 3, the nut 92 above the base portion 31 is fastened. Thus, the base portion 31 is pressed by the nut 92, the pair of leg portions 34 of the first fastening bracket 21 abuts against the bottom wall portion 20c of the rack member 20, and the first fastening bracket 21 is fastened to the rack member 20. At this time, a distance between the upper surface of the rack member 20 and the second engaging portion 36 is the same as a distance between the lower surface of the second base portion 43a2 and the upper end of the second to-be-engaged portion 43c. Therefore, the second base portion 43a2 and the second to-be-engaged portion 43c are held in the facing direction of the rack member 20 and the second engaging portion 36 by the rack member 20 and the second extending portion 36a of the second engaging portion 36, and the inclined surface of the second engaging wall 36b and the inclined surface of the second to-be-engaged portion 43c abut against each other.

Accordingly, the module cover 5 holds the rack member 20 and the first fastening bracket 21 in two directions, that is, the longitudinal direction of the rack member 20 and the direction orthogonal to the upper surface of the rack member 20. At this time, for example, the first engaging wall 35b and the first to-be-engaged portion 43b are separated from each other. When a force is applied to the module cover 5 in a direction of separation away from the first fastening bracket 21, the module cover 5 is prevented from coming off the first fastening bracket 21 by the engagement between the second engaging wall 36b and the second to-be-engaged portion 43c, and even when a force is further applied and the module cover 5 moves from the first fastening bracket 21, the first to-be-engaged portion 43b abuts against the first engaging wall 35b, thus the movement of the module cover 5 in a direction of separation away from the wall portion 32 is restricted, and the module cover 5 can be prevented from coming off the first fastening bracket 21.

The module cover 5 and the photovoltaic power generation system 1 configured as described above can guide rainwater to the rain gutter 508 by the module cover 5. To be more specific, as indicated by an arrow F1 in FIG. 2, rainwater flowing on the solar panel 10 of the photovoltaic module 2 flows over the frame 11. At this time, since a gap is formed between the frame 11 and the module cover 5, the rainwater moves into the module cover 5. Then, the rainwater flowing into the module cover 5 is guided downward along the rack member 20 and/or the side plate 42 and/or the to-be-engaged portion 43 of the module cover 5. Accordingly, the rainwater moves to the rain gutter 508.

Therefore, in the photovoltaic power generation system 1, in a case where the photovoltaic module 2 is provided on the eaves side of the roof 500, even if the separation distance from the end portion of the roofing member 506 on the eaves side to the photovoltaic module 2 is 0 mm, rainwater is not caused to flow down from the eaves, and rainwater can be guided to the rain gutter 508 by the module cover 5. Therefore, by using the module cover 5, the photovoltaic power generation system 1 can increase the installation area in which the photovoltaic module 2 can be installed on the roof 500.

Further, the upper surface on the tip end side of the top plate 41 of the module cover 5 is inclined. Therefore, in winter, snow that has accumulated on the photovoltaic module 2 is likely to run onto the top plate 41 due to the inclination of the top plate 41 of the module cover 5. As a result, as indicated by the arrow F2 in FIG. 2, snow on the photovoltaic module 2 moves along the inclination of the photovoltaic module 2, and falls under the eaves over the top plate 41, and thus the photovoltaic module 2 and the module cover 5 can be prevented from being damaged by accumulated snow.

In this manner, the module cover 5 forms a gap for allowing rainwater to flow below the top plate 41 and makes the gap between the top plate 41 and the frame 11 small, thus making it possible to move snow onto the upper surface of the top plate 41. That is, the module cover 5 can make rainwater and snow move in different routes.

The module cover 5 can be fastened to the rack member 20 and the first fastening bracket 21 by arranging the to-be-engaged portion 43 between the first fastening bracket 21 and the rack member 20 in the state where the base portion 31 is temporarily fastened by the nut 92, and then fastening the nut 92. That is, the module cover 5 can be fastened together with the operation of fastening the first fastening bracket 21 to the rack member 20 with the nut 92. Therefore, the module cover 5 can be easily fastened to the first fastening bracket 21.

As described above, according to the module cover (rainwater guide cover) 5 and the photovoltaic power generation system 1, the photovoltaic module 2 can be installed up to the end portion of the roofing member 506 on the eaves side, and rainwater can be guided to the rain gutter 508 below.

In the example described above, the example in which the to-be-engaged portion 43 is engaged with the first engaging portion 35 and the second engaging portion 36 of the first fastening bracket 21 has been described as an example in which the module cover 5 is held and fastened by the first fastening bracket 21. However, the method of fastening the module cover 5 to the first fastening bracket 21 is not limited to the above-described example. Various configurations can be applied as a method of fastening the module cover 5 to the first fastening bracket 21, as long as a part of the module cover 5 can be held by the rack member 20 and the first fastening bracket 21 in a direction orthogonal to the upper surface of the rack member 20, and can be held by the first fastening bracket 21 in at least two directions in which the first fastening bracket 21 and the module cover 5 are separated along the main surface direction of the upper surface of the rack member 20 (the longitudinal direction of the rack member 20).

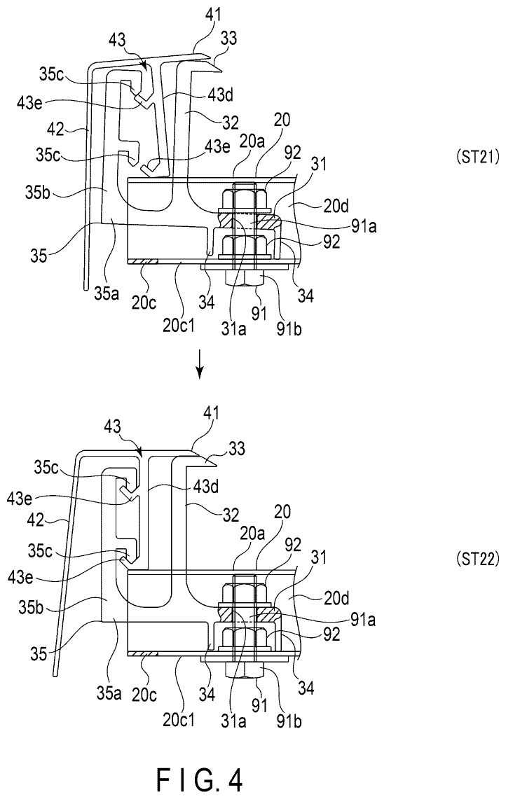

For example, an example of a second embodiment illustrated in FIG. 4 will be described. As illustrated in FIG. 4, a first fastening bracket 21 does not have a second engaging portion 36, but has a first engaging wall 35b of a first engaging portion 35 which is increased in height, and has two or more engaging protrusions 35c on a surface of the first engaging wall 35b facing a wall portion 32 and at different positions in the height direction. The engaging protrusions 35c extend from the first engaging wall 35b toward the wall portion 32, are formed in an L-shape in a side view toward a first extending portion 35a, and a lower end is formed as V-shaped inclined surfaces.

A module cover 5 has, as a to-be-engaged portion 43, a plate-shaped board 43d extending from a lower surface of a top plate 41, and two or more to-be-engaged protrusions 43e that are formed on a surface of the board 43d facing a side plate 42 and that engage with the engaging protrusions 35c at different positions in the height direction. A lower end of the board 43d is a surface along a main surface of the top plate 41, and, in a case where the module cover 5 is fastened to the first fastening bracket 21, is a surface along an upper surface of the rack member 20.

The to-be-engaged protrusion 43e has an upper surface having a same inclination angle as a lower surface of the engaging protrusion 35c. In this way, the first fastening bracket 21 and the module cover 5 may be configured such that the engaging protrusions 35c and the to-be-engaged protrusions 43e can be engaged with each other at two or more different positions in the height direction. In the case where the first fastening bracket 21 is fastened to the rack member 20, a distance between the lower surface of the engaging protrusion 35c on the lower side and the rack member 20 is the same as a distance between the upper surface of the to-be-engaged protrusion 43e on the lower side and the lower surface of the board 43d.

With such a configuration, as illustrated in step ST21 of FIG. 4, the board 43d of the module cover 5 is arranged between the wall portion 32 and the first engaging wall 35b of the first fastening bracket 21 temporarily fastened by the nut 92, and as illustrated in step ST22, the engaging protrusions 35c and the to-be-engaged protrusions 43e are engaged respectively, and the nut 92 on the base portion 31 is fastened, to thus hold the module cover 5 by the lower to-be-engaged protrusion 43e being held by the lower engaging protrusion 35c and the rack member 20. Further, in the to-be-engaged portion 43, the board 43d faces the first engaging wall 35b, and the inclined upper surfaces of the two or more to-be-engaged protrusions 43e abut on the inclined lower surfaces of the engaging protrusions 35c. Therefore, in the case where the module cover 5 is to be moved in a direction of separation away from the first fastening bracket 21 toward the side opposite to the ridge side, the first engaging portion 35 and the to-be-engaged portion 43 engage to restrict the movement, and the module cover 5 can be prevented from falling off the first fastening bracket 21.

Further, the module cover 5 having such a configuration may be configured such that the board 43d is inserted between the wall portion 32 and the first engaging wall 35b of the first fastening bracket 21 from above, and thus the top plate 41 and the support portion 33 can be brought close to each other. Therefore, the fastening device 3 and the module cover 5 can make the gap between the frame 11 of the photovoltaic module 2 and the top plate 41 small, and thus the height of the module cover 5 can be reduced. The module cover 5 can thus make it easy for accumulated snow to run onto the top plate 41 while maintaining the rainwater guiding performance.

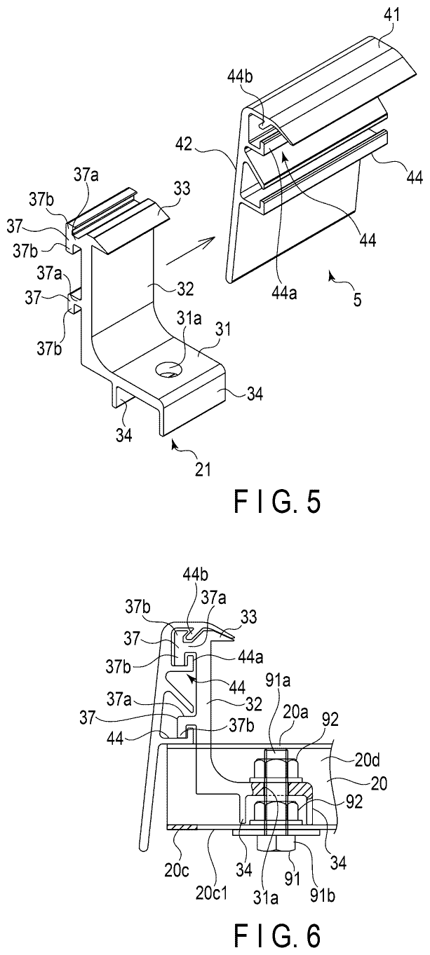

As another example, an example of a third embodiment illustrated in FIGS. 5 and 6 will be described. As illustrated in FIG. 5, a first fastening bracket 21 may be configured to not have a first engaging portion 35 and a second engaging portion 36, and may be configured such that a module cover 5 and the first fastening bracket 21 relatively slide in the longitudinal direction of the module cover 5 and can be engaged in a direction in which the module cover 5 separates from the first fastening bracket 21.

For example, such a first fastening bracket 21 may be configured to not have a first engaging portion 35 and a second engaging portion 36, and have a plurality of engaging protrusions 37 having surfaces in two directions intersecting each other on the surface of a wall portion 32 on the opposite side to the surface facing the photovoltaic module 2, and the module cover 5 may have, on an inner surface of a side plate 42, a plurality of to-be-engaged protrusions 44 that engage with the plurality of engaging protrusions 37. The module cover 5 may be configured such that the plurality of to-be-engaged protrusions 44 are provided on a board 43d provided to the top plate 41 described above, instead of providing the to-be-engaged protrusions 44 on the side plate 42.

The engaging protrusion 37 and the to-be-engaged protrusion 44 may have surfaces that can abut in at least two directions. For example, as illustrated in FIGS. 5 and 6, two engaging protrusions 37 and two to-be-engaged protrusions 44 are provided. For example, the lower engaging protrusion 37 includes an extending portion 37a extending from the side surface of the wall portion 32 and an engaging wall 37b extending downward at an end portion of the extending portion 37a, and the lower engaging protrusion 37 is formed in an L-shape in a side view. The lower to-be-engaged protrusion 44 is formed in an L-shape in a side view, and protrudes from the side plate 42 and extends upward at an end portion.

The lower engaging protrusion 37 and the lower to-be-engaged protrusion 44 are formed to be able to abut against each other in the vertical direction along the wall portion 32 and to be able to abut in a direction orthogonal to the vertical direction. The upper engaging protrusion 37 includes an extending portion 37a protruding from the side surface of the wall portion 32 and two engaging walls 37b each extending in the vertical direction at the end portion of the extending portion 37a, and the upper engaging protrusion 37 is formed in a T-shape in a side view. The upper to-be-engaged protrusion 44 protrudes from the side plate 42 and includes a side plate-side to-be-engaged protrusion 44a extending upward at an end portion and having an L-shape in a side view and a top plate-side to-be-engaged protrusion 44b protruding downward from the top plate 41. The upper engaging protrusion 37 and the upper to-be-engaged protrusion 44 are formed to be able to abut against each other in the vertical direction and in a direction orthogonal to the vertical direction. As illustrated in FIG. 6, the engaging wall 37b extending upward of the upper engaging protrusion 37 and the top plate-side to-be-engaged protrusion 44b of the upper to-be-engaged protrusion 44 may be shaped inclined with respect to the wall portion 32, for example, and may be configured to abut against each other in the vertical direction and in a direction orthogonal to the vertical direction. Further, the plurality of engaging protrusions 37 may have a same shape, and the plurality of to-be-engaged protrusions 44 may have a same shape.

The first fastening bracket 21 and the module cover 5 having such a configuration include the engaging protrusion 37 and the to-be-engaged protrusion 44 which engage with each other by the relative sliding movement in the direction along the longitudinal direction of the module cover 5, and thus the first fastening bracket 21 and the module cover 5 can be formed with minimum material and can be firmly fastened. The first fastening bracket 21 and the module cover 5 are engaged with each other, for example, before the first fastening bracket 21 is fastened or temporarily fastened to the rack member 20, but may be engaged with each other after the first fastening bracket 21 is temporarily fastened to the rack member 20.

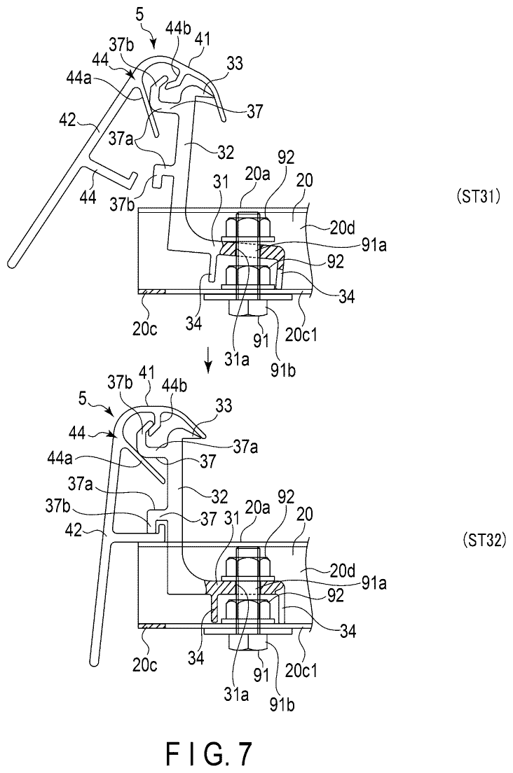

As another example, an example of a fourth embodiment illustrated in FIG. 7 will be described. As in steps ST31 and ST32 illustrated in FIG. 7, a module cover 5 may be configured to be installed by being rotated so as to cover first fastening brackets 21 temporarily fastened to a rack member 20.

For example, as illustrated in FIG. 7, the first fastening bracket 21 may be configured to not have a first engaging portion 35 and a second engaging portion 36 and have two engaging protrusions 37 having surfaces in two intersecting directions on a surface of a wall portion 32 on the opposite side to the surface facing a photovoltaic module 2, and the module cover 5 may be configured to have two to-be-engaged protrusions 44, on the inner surface of the side plate 42, which engage with the lower engaging protrusion 37 at the lower part and the upper engaging protrusion 37 at the upper part, respectively, of the two engaging protrusions 37.

For example, as illustrated in FIG. 7, the lower engaging protrusion 37 has an extending portion 37a protruding from the side surface of the wall portion 32 and an engaging wall 37b protruding downward from an end portion of the extending portion 37a, and the lower engaging protrusion 37 is formed in an L-shape in a side view. The upper engaging protrusion 37 includes an extending portion 37a that protrudes from the side surface of the wall portion 32, and an engaging wall 37b that protrudes upward from an end portion of the extending portion 37a and has an upper end side inclined toward the wall portion 32 side, and the upper engaging protrusion 37 is formed in substantially an L-shape in a side view.

The lower to-be-engaged protrusion 44 protrudes from the side plate 42 and extends upward at an end portion, and is formed in an L-shape in a side view. The upper to-be-engaged protrusion 44 has a plate-shaped side plate-side to-be-engaged protrusion 44a that protrudes downward from the side plate 42 in an inclined manner and a top plate-side to-be-engaged protrusion 44b that protrudes downward from the top plate 41 and is inclined toward the side plate 42 side at a lower end side.

The lower engaging protrusion 37 and the lower to-be-engaged protrusion 44 are formed to be able to abut against each other in the vertical direction and to be able to abut against each other in a direction orthogonal to the vertical direction. The extending portion 37a and a ridge portion of the engaging wall 37b of the upper engaging protrusion 37 engage with the side plate-side to-be-engaged protrusion 44a in the vertical direction and in a direction orthogonal to the vertical direction and in which the wall portion 32 and the side plate 42 approach each other. An inclined surface at the upper end of the engaging wall 37b abuts against an inclined surface at the tip end of the top plate-side to-be-engaged protrusion 44b in the vertical direction and in a direction orthogonal to the vertical direction and in which the wall portion 32 and the side plate 42 separate away from each other.

With such a configuration, as illustrated in step ST31 of FIG. 7, from a state where a support portion 33 of the first fastening bracket 21 to which a nut 92 is temporarily fastened is covered with the lower surface of the module cover 5, as illustrated in step ST32, the module cover 5 is rotationally moved to engage the two engaging protrusions 37 and the two to-be-engaged protrusions 44, and the nut 92 is fastened. Thus, the to-be-engaged protrusions 44 can be held between the rack member 20 and the engaging protrusions 37 of the first fastening bracket 21 in the vertical direction, and the engaging protrusions 37 and the to-be-engaged protrusions 44 are able to abut against each other in a direction of separation away from the first fastening bracket 21.

With the first fastening bracket 21 and the module cover 5 having such a configuration, the module cover 5 can be fastened to the first fastening bracket 21 by installing the module cover 5 so as to cover the temporarily fastened first fastening bracket 21 and fastening the nut 92.

As illustrated in some embodiments, the fastening device 3 and the module cover 5 may be configured to fasten by engaging at a plurality of locations in the direction orthogonal to the upper surface of the rack member 20, that is, in at least two directions of the longitudinal direction of the rack member 20 (the direction in which the eaves and the ridge are opposed to each other) and the direction orthogonal to the upper surface of the rack member 20.

The present invention is not limited to the above embodiments, and can be modified in various ways without departing from the scope of the invention in the implementation stage. The embodiments may be combined as appropriate, and in such a case combined effects can be obtained. Furthermore, the above embodiments include various inventions, and various inventions can be extracted by combinations selected from a plurality of disclosed constituent features. For example, even if some of the constituent features are deleted from all the constituent features described in the embodiments, the configuration from which these constituent features are deleted can be extracted as an invention as long as the problem can be solved and the effects can be obtained.

### REFERENCE SIGNS LIST

1 photovoltaic power generation system, 2 photovoltaic module, 3 fastening device, 5 module cover (rainwater guide cover), 10 solar panel, 11 frame, 12 cell, 20 rack member, 20a support plate portion, 20b opening portion, 20c bottom wall portion, 20c1 hole, 20d side wall portion, 21 first fastening bracket, 22 second fastening bracket, 31 base portion, 31a hole, 32 wall portion, 33 support portion, 34 leg portion, 35 first engaging portion, 35a first extending portion, 35b first engaging wall, 35c engaging protrusion, 36 second engaging portion, 36a second extending portion, 36b second engaging wall, 37 engaging protrusion, 37a extending portion, 37b engaging wall, 41 top plate, 42 side plate, 43 to-be-engaged portion, 43a base portion, 43a1 first base portion, 43a2 second base portion, 43b first to-be-engaged portion, 43c second to-be-engaged portion, 43d board, 43e to-be-engaged protrusion, 44 to-be-engaged protrusion, 44a side plate-side to-be-engaged protrusion, 44b top plate-side to-be-engaged protrusion, 91 bolt, 91a male screw, 91b head portion, 92 nut, 500 roof, 501 rafter, 502 eaves soffit, 504 roof board, 505 material, 506 roofing member, 507 drip edge, 507a base portion, 507b drip edge flashing, 508 rain gutter.

1. A rainwater guide cover, comprising:
a top plate configured to cover above a part on an eaves side of a fastening device that attaches a photovoltaic module to a roof, the top plate being arranged with a gap from the photovoltaic module; and
a side plate provided to the top plate, the side plate being configured to cover an eaves side of the photovoltaic module and including a lower end arranged to face a rain gutter.

2. The rainwater guide cover according to claim 1, further comprising:
a plurality of to-be-engaged portions configured to engage with the fastening device in two directions.

3. A photovoltaic power generation system, comprising:
the rainwater guide cover according to claim 1;
the photovoltaic module including a solar panel and a frame configured to hold the solar panel; and
the fastening device including a rack member configured to support the frame and a fastening bracket including a support portion that can arrange the frame between the rack member and the support portion.

4. The photovoltaic power generation system according to claim 3, wherein
the fastening bracket includes an engaging portion configured to engage with a to-be-engaged portion provided on the rainwater guide cover in an extending direction of the rack member and a direction orthogonal to an upper surface of the rack member.

5. The photovoltaic power generation system according to claim 4, wherein
the fastening bracket includes a base portion fastened to the rack member by a fastening member, and a wall portion provided to the base portion, the wall portion being provided with the support portion on an upper end and being configured to face the photovoltaic module,
the engaging portion includes a first engaging portion provided on a side of the wall portion opposite to a side on which the photovoltaic module is provided and extending in a same direction as the wall portion, and a second engaging portion provided on a side of the wall portion opposite to the support portion and extending in the same direction as the wall portion, and
the to-be-engaged portion is held between the rack member and the second engaging portion, and includes a first to-be-engaged portion and a second to-be-engaged portion which engage with the first engaging portion and the second engaging portion in a direction of separation away from the wall portion.

6. A photovoltaic power generation system, comprising:
the rainwater guide cover according to claim 2;
the photovoltaic module including a solar panel and a frame configured to hold the solar panel; and
the fastening device including a rack member configured to support the frame and a fastening bracket including a support portion that can arrange the frame between the rack member and the support portion.

7. The photovoltaic power generation system according to claim 6, wherein
the fastening bracket includes an engaging portion configured to engage with a to-be-engaged portion provided on the rainwater guide cover in an extending direction of the rack member and a direction orthogonal to an upper surface of the rack member.

8. The photovoltaic power generation system according to claim 7, wherein
the fastening bracket includes a base portion fastened to the rack member by a fastening member, and a wall portion provided to the base portion, the wall portion being provided with the support portion on an upper end and being configured to face the photovoltaic module,
the engaging portion includes a first engaging portion provided on a side of the wall portion opposite to a side on which the photovoltaic module is provided and extending in a same direction as the wall portion, and a second engaging portion provided on a side of the wall portion opposite to the support portion and extending in the same direction as the wall portion, and
the to-be-engaged portion is held between the rack member and the second engaging portion, and includes a first to-be-engaged portion and a second to-be-engaged portion which engage with the first engaging portion and the second engaging portion in a direction of separation away from the wall portion.
